(19) United States
(12) Patent Application Publication
(10) Pub. No.: US 2006/0216196 A1
(43) Pub. Date: Sep. 28, 2006

(54) Narrow swab (access swab) for ATP Measurement

(75) Inventors: Paul Satoh, Holt, MI (US); Donald W. Pielack, Holt, MI (US); James L. Topper, East Lansing, MI (US); Clifton Brown, East Lansing, MI (US)

Correspondence Address: Ian C. McLeod;McLEOD & MOYNE, P.C., 2190 Commons Parkway, Okemos, MI, 48864, US

(73) Assignee: Neogen Corporation, Lansing, MI (US)

(21) Appl. No.: 11/088,192

(22) Filed: Mar. 23, 2005

(51) Int. Cl. G01N 31/22

(52) U.S. Cl. 422/61; 422/58

(57) ABSTRACT

A device and methods for the rapid chemiluminescence or calorimetric assay of surfaces to detect the presence of microbial or protein contamination is disclosed. A sampling/analysis member (10) is described having a sampling wand (15) which is suitable for use by untrained personnel under the relatively harsh and variable conditions found in the field, for example in fast food restaurants and other food preparation areas. The analytical signal in the disclosed device and methods can be based on luciferase/luciferin systems or a protein assay systems utilizing bicinchoninic acid.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

(1) Field of the Invention

The present invention relates, in general, to a device and method for the rapid and semi-automated assay of proteins and materials indicative of the presence of microbial species such as bacteria.

(2) Description of the Related Art

The ability to rapidly and conveniently detect microorganisms is important for several industries, such as food preparation, medicine, beverages, toiletries, and pharmaceuticals. For example, the ability to detect bacterial contamination, particularly on surfaces, is paramount to improving safety in food processing and food service industries. During food processing, food can become contaminated with bacteria and then spoil. Furthermore, such contamination can be spread through contact of food with contaminated surfaces. Food poisoning can result if food contaminated with pathogenic bacteria, or its toxic products, is ingested without proper cooking. In addition, spread of disease in hospitals and other facilities often occurs as a result of the passage of infectious microbes on the surface of clothes or equipment. In light of this potential hazard, it is not enough to simply clean or sanitize a surface and assume it is free from microorganisms such as bacteria. Instead, there is a critical need to perform a test to detect whether the surface is actually free of microorganisms. Thus, random areas of a surface, such as a food preparation surface, can be tested for microorganisms to determine the general cleanliness of the surface.

One of the oldest methods to check for cleanliness involves culturing samples for bacteria. While the results of bacterial cultures are accurate, they are limited by the time that it takes to incubate the culture, usually on the order of days. Unfortunately, such prior art methods for detecting bacterial contamination are too cumbersome and time consuming for immediate use by untrained workers. In particular, much more rapid bacterial assays are needed, particularly in slaughterhouses and food handling establishments. In these locations one must rapidly determine whether additional cleaning methods are required or whether proper safety procedures have been followed. Bacterial assays would be a useful component of a “hazards and critical control points program” (HCCP) to monitor and control bacterial contamination. However, typical bacterial assays based on cell culture techniques cannot provide results within a meaningful time frame.

In response for a need to obtain results more quickly, other methods for detecting microorganisms have been developed. The most productive area of development has focused on the detection of biomass on the test surface. Biomass includes living cells, dead cells, and other biotic products such as blood, and food residue. Biomass can be detected by an assay for ATP, adenosine triphosphate, a chemical found in all living organisms.

This assay is generally based on the “firefly” biochemical reaction that produces the characteristic bioluminescence associated with fireflies. The specific chemistry of this reaction will be discussed in more detail below. When appropriate reagents are mixed with a sample taken from a test surface, extracellular ATP immediately reacts and generates detectable chemiluminescence. However, intracellular ATP cannot be detected unless the ATP is first extracted from within the cells. Typically, this is accomplished by mixing the sample with an extraction reagent (releasing reagent) that extracts the ATP from within the cells or lyses the cells to permit access of ATP to chemiluminescent reagents. Typical extraction reagents are detergents. The extracted ATP then can be mixed with the luciferase/luciferin reagent to produce the observable reaction. It is important that the extraction reagent chosen does not inactivate the reagents. An additional consideration is the toxicity of the lysing agent, particularly when used on food preparation surfaces.

While the related art teach assays for proteins and microbial species, there still exists a need for improved methods and devices for the rapid and semi-automated assay of proteins and materials indicative of the presence of microbial species such as bacteria.

### OBJECTS

Therefore, it is an object of the present invention to provide an improved device for which can test for an analyte of interest in a sample.

It is further an object of the present invention to provide methods of using the device.

These and other objects will become increasingly apparent by reference to the following description.

### SUMMARY OF THE INVENTION

The present invention provides a sampling/analysis member which is used to assay for an analyte of interest in a sample comprising: (a) a sampling wand having a sampling swab at a proximal end for collecting the sample of the analyte of interest and a distal end for handling of the sampling wand; (b) a tubular container containing a rinsing solution mounted on the sampling wand with an open end containing a liquid water-insoluble polymer as a stopper for the solution adjacent the swab at the proximal end and a sealed end adjacent the distal end, wherein a portion of the tubular container intermediate the ends is frangible; and (c) an analysis structure for receiving the sample of the analyte of interest rinsed from the sampling swab by the rinsing solution upon rupture of the portion of the tubular container which is frangible and for retaining the analyte for the detection of the presence of the analyte of interest in the sample.

In further embodiments the analysis structure has a reagent disc onto which a reactant system for the analyte in the solution has been loaded. In further embodiments the reagent disc is a polymeric material. In further embodiments the polymeric material is a silicone polymer. In further embodiments the polymeric material has a cylindrical shape. In further embodiments the tubular container is mounted along a longitudinal axis of the sampling wand. In further embodiments a rupturing member is provided at the distal end of the sampling wand so as to bend the tubular container to rupture the frangible portion. In further embodiments the rupturing member comprises a pivotable arm adjacent to the tubular container at the distal end of the sampling wand. In further embodiments the pivotable arm is bendable so as to pivot. In further embodiments the rupturing member is comprised of a plastic material.

The present invention provides a sampling wand comprising: (a) a sampling swab at a proximal end for collecting a sample of an analyte of interest and a distal end for handling of the sampling wand; (b) a tubular container containing a solution mounted on the sampling wand with an open end containing a liquid water-insoluble polymer as a stopper for the solution adjacent the swab at the proximal end and a sealed end adjacent the distal end, wherein a portion of the tubular container intermediate the ends is frangible so as to release the solution and water-insoluble polymer into the sampling swab; and (c) a rupturing member on the sampling wand adjacent to the tubular member for rupturing the portion which is frangible.

In further embodiments the tubular container is mounted along a longitudinal axis of the sampling wand. In further embodiments a rupturing member is provided at the distal end of the sampling wand so as to bend the tubular container to rupture the frangible portion. In further embodiments the rupturing member comprises a pivotable arm adjacent to the tubular container at the distal end of the sampling wand. In further embodiments the pivotable arm is bendable so as to pivot. In further embodiments the rupturing member is comprised of a plastic material.

The present invention provides a method for assaying for an analyte of interest in a sample which comprises: (a) providing a sampling wand at a proximal end for collecting a sample of an analyte of interest and a distal end for handling of the sampling wand; a tubular container containing a solution mounted on the sampling wand with an open end containing a liquid water-insoluble polymer as a stopper for the solution adjacent the swab at the proximal end and a sealed end adjacent the distal end, wherein a portion of the tubular container intermediate the ends is frangible so as to release the solution and water-insoluble polymer into the sampling swab; and a rupturing member on the sampling wand adjacent to the tubular member for rupturing the portion which is frangible; (b) rubbing the swab on the wand on a surface to retain any of the analyte on the swab; (c) inserting the sampling wand into an analysis structure for receiving the sample of interest; (d) rupturing the tubular container with the rupturing member so as to release the solution and the liquid water insoluble polymer into and through the swab into the analysis structure; and (e) detecting any of the analyte in the analysis structure.

In further embodiments the analysis structure has a reagent disc onto which a reactant system for the analyte in the solution has been loaded and wherein the analyte in the solution reacts with the reactant system. In further embodiments the reagent disc is a polymeric material. In further embodiments the polymeric material is a silicone polymer. In further embodiments the polymeric material has a cylindrical shape. In further embodiments the tubular container is mounted along a longitudinal axis of the sampling wand and the rupturing is at the distal end of the tubular container. In further embodiments the swab is pre-wetted. In further embodiments the swab is pre-wetted with a detergent, a hygroscopic agent, or a mixture thereof. In further embodiments the hygroscopic agent is glycerol, polypropylene glycol, or polyethylene glycol. In further embodiments the swab is pre-wetted with 10% glycerol.

The present invention provides a sampling wand comprising: (a) a sampling swab at a proximal end of the distal end of the wand for collecting a sample of an analyte of interest and having a distal end for handling of the sampling wand; and (b) a container containing a solution mounted on the sampling wand with an open end comprising a liquid water-insoluble polymer for the solution adjacent the swab at the proximal end and a sealed end adjacent the distal end, wherein a portion of the tubular container intermediate the ends is operable so as to release the solution and water-insoluble polymer into the sampling swab, thereby enabling the detection of the analyte on the swab in the solution. In further embodiments the sampling wand is mounted in an analysis structure for detection of the analyte in the solution. In still further embodiments of the sampling wand the container is tubular.

### BRIEF DESCRIPTION OF THE DRAWINGS

FIG. 1 illustrates an exploded, perspective view of one embodiment of a sampling/analysis member 10 of the present invention.

FIG. 2 illustrates an exploded, perspective view of the sampling/analysis member 10 with an assembled sampling wand 15.

FIG. 3 illustrates an exploded, perspective view of the sampling/analysis member 10 with an assembled sampling wand 15 inserted into a sleeve 40.

FIG. 4 illustrates an exploded, perspective view of the sampling/analysis member 10 with the sampling wand 15 and sleeve 40 inserted into the inner chamber 60 of the analysis structure 80.

FIG. 5 illustrates a perspective view of an assembled sampling/analysis member 10 with the sampling wand 15 partially inserted into the analysis structure 80.

FIG. 6 illustrates a perspective view of an assembled sampling/analysis member 10 with the sampling wand 15 fully inserted into the analysis structure 80.

FIG. 7 is a cross-sectional view taken along line 7-7 of FIG. 3 showing sampling wand 15. FIG. 7A is a close-up view of the frangible end 28 of the sampling wand 15 illustrated in FIG. 7. FIG. 7B is a cross-sectional view of the handle portion 30 of the sampling wand 15 taken along line 7B-7B of FIG. 7.

FIG. 8 illustrates a perspective cut-away view of a pipe 90 with the sampling wand 15 inserted to collect a sample from the inside surface of the pipe 90.

FIG. 9 is a cross-sectional view taken along line 9-9 of FIG. 5 showing sampling/analysis member 10 prior to release of the solution 82.

FIG. 10 is a cross-sectional view taken along line 10-10 of FIG. 6 showing sampling/analysis member 10 after release of the solution 82.

### DETAILED DESCRIPTION OF THE INVENTION

All patents, patent applications, government publications, government regulations, and literature references cited in this specification are hereby incorporated herein by reference in their entirety. In case of conflict, the present description, including definitions, will control.

As used herein, the terms “polymer” and “polymeric” refers to a variety of organic polymers or silicon polymers such as silicones and siloxanes. One type of organic polymeric material is composed of the reaction product of polyvinyl alcohol and an aldehyde.

In general, the present invention provides an apparatus and methods that make possible the rapid detection through chemiluminescence of materials indicative of the presence of a microbial species such as bacteria, or a color reaction of materials indicative of the presence of protein on a surface. The present invention is capable of use by unskilled operators under the relatively harsh field environment of institutional food preparation services, health care providers and the like. The results of the color reaction for protein are easily detected visually, but can also be determined spectrophotometrically as described in U.S. patent application Ser. No. 11/044,147 to Satoh et al. hereby incorporated herein by reference. The results of the chemiluminescence reaction are determined by a hand-held luminometer as disclosed in U.S. Pat. Nos. 6,653,147; 6,548,018; and 6,541,194 to DiCesare et al. hereby incorporated herein by reference. Further chemiluminescent and chromogenic methods and devices are disclosed in U.S. patent application Ser. Nos. 09/821,301; 09/887,703; 09/821,571; 10/326,332; 10/346,328; 10/346,625 to DiCesare et al., and 10/426,169 to Mayer each of which are hereby incorporated herein by reference in their entirety.

Bioluminescence refers to the visible light emission in living organisms that accompanies the oxidation of organic compounds such as luciferins, mediated by an enzyme catalyst, such as luciferase. Luminescent organisms, which include bacteria, fungi, fish, insects, algae, and squid, have been found in marine, freshwater, and terrestrial habitats, with bacteria being the most widespread, and abundant, luminescent organism in nature. Although their primary habitat is in the ocean in free-living, symbiotic, saprophytic or parasitic relationships, some luminescent bacteria are found in terrestrial or freshwater habitats. The enzymes involved in the luminescent (lux) system, including luciferase, as well as the corresponding lux genes, have been most extensively studied from the marine bacteria in the Vibrio and Photobacterium genera and from terrestrial bacteria in the Xenorhabdus genus, in particular the Vibrio harveyi, Vibrio fischeri, photobacterium phosphoreum, Photobacterium leiognathi, and Xenorhabdus luminescens species. It has been found that the light-emitting reactions are quite distinct for different organisms, with the only common component being molecular oxygen. Therefore, significant differences have been found between the structures of the luciferases and the corresponding genes from one luminescent organism to another.

Chemiluminescent reactions can be used in various forms to detect bacteria in fluids and in processed materials. In the practice of the present invention, a chemiluminescent reaction based on the reaction of adenosine triphosphate (ATP) with luciferin in the presence of the enzyme luciferase to produce light provides the chemical basis for the generation of a detectable analytical signal. Since ATP is present in all living cells, including all microbial cells, this method can provide a rapid assay to obtain a quantitative or semi-quantitative estimate of the number of living cells in a sample, or on a sample surface. Early discourses on the nature of the underlying reaction, the history of its discovery, and its general area of applicability, are provided by E. N. Harvey (1957), A History of Luminescence: From the Earliest Times Until 1900, Amer. Phil. Soc., Philadelphia, Pa.; and W. D. McElroy and B. L. Strehler (1949), Arch. Biochem. Biophys. 22:420-433.

ATP detection is a reliable means to detect bacteria and other microbial species because all such species contain some ATP. Chemical bond energy from ATP is utilized in the bioluminescent reaction that occurs in the tails of the firefly Photinus pyralis. The biochemical components of this reaction can be isolated free of ATP and subsequently used to detect ATP in other sources. Alternatively, the genes producing the proteins that participate in the bioluminescent reaction can be isolated, cloned into a suitable expression system, and used to produce a recombinant form of the luminescent reactants. Examples of such techniques are disclosed in U.S. Pat. No. 5,741,668, the specific disclosure of which is hereby incorporated by reference. The mechanism of this firefly bioluminescence reaction has been well characterized (DeLuca, M., et al., 1979 Anal. Biochem. 95:194-198). Of note is that luciferase-based assays differ from most familiar enzyme-based analytical determinations. Most enzyme-based assays monitor either the production of a product or the disappearance of a substrate. Usually, the compound measured is stable so that its concentration can be determined after a specific time. At low adenosine 5′-triphosphate (ATP) concentrations, however, the kinetics of the luciferase reaction approach pseudo-first order behavior.

In the case of the luciferase reaction, AMP, PPᵢ, CO₂, and oxyluciferin are typical products that accumulate, but the product that provides the analytical signal is light. The two-step luciferase reaction sequence is shown below. Step one forms an enzyme-bound luciferyl adenylate. Either Mg-ATP or LH₂ (luciferin) can add first to the enzyme LUC.
LH₂+MgATP+LUC→LUC-LH₂-AMP+MgPP₁ (1)

Step two is the oxidative decarboxylation of luciferin with the production of light on decay of the excited form of oxyluciferin.
LUC-LH₂-AMP+O₂+OH⁻→LUC-OL+CO₂+AMP+light (550-570 nm)+H₂O (2)

The oxyluciferin product, OL, is released slowly from the enzyme-product complex. This gives the flash kinetic pattern observed with high ATP concentrations, not typically encountered under conditions of practice of the present invention, under which conditions the luciferase acts catalytically. The initial flash of light emission observed with high ATP concentration is owing to a “first round” of enzyme activity. This flash rapidly decays to a relatively constant light emission, similar to that seen at low ATP concentrations, which is thought to be the result of the enzyme slowly turning over by releasing the oxyluciferin.

The preferred embodiment of the sampling/analysis member 10 can be used with a hand-held luminometer described in U.S. Pat. Nos. 6,653,147; 6,548,018; and 6,541,194 to DiCesare et al., which is designed to accept the sampling/analysis member 10. The luminometer can be a scale that can easily fit into an operator's hand, making possible essentially single-handed operation. When using such a luminometer, the sampling/analysis member 10 can be held in one hand and easily inserted in a sample port of the luminometer as the operator holds the device in the operator's other hand. Once the internal electronics of the luminometer are in a ready state, full insertion of the sampling wand 10 into the assembly already inserted into the luminometer brings the chemiluminescent reaction into close proximity to the luminometer's detector circuitry. A digital readout is then displayed on the luminometer's display screen informing the operator of the relative hygienity of the sampled surface based upon the detection of chemiluminescence which indicates the presence of ATP from microbial cells. For further details regarding the mechanical and electronic structure of the luminometer device of the present invention, the reader is referred to application Ser. No. 09/821,571, the disclosure of which is hereby specifically incorporated by reference.

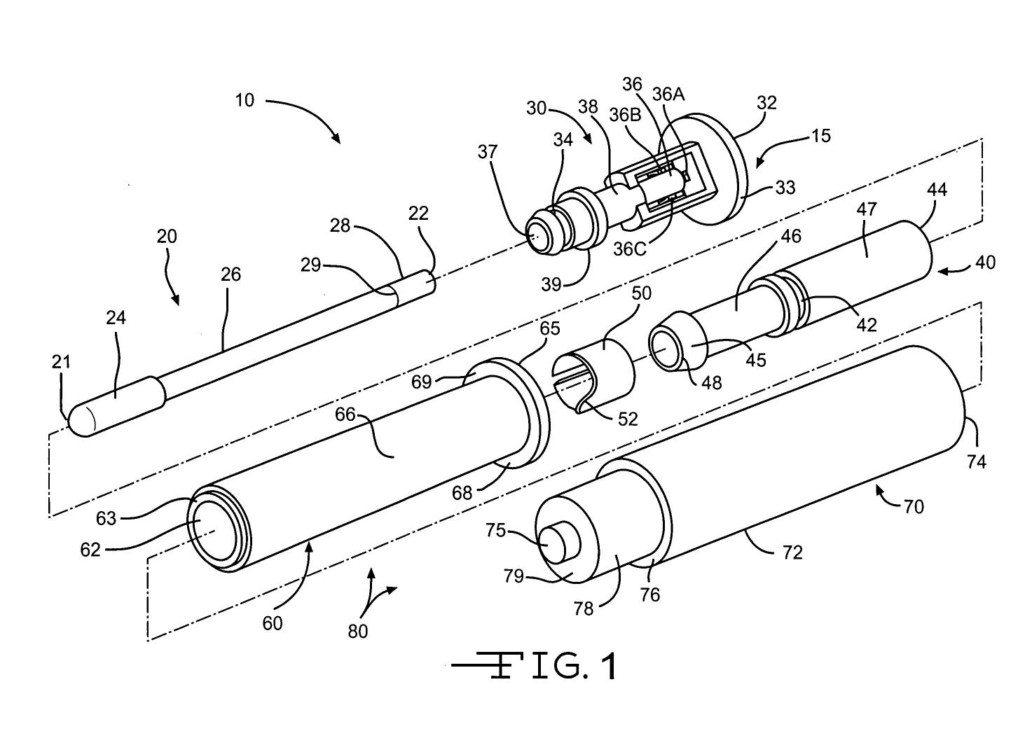

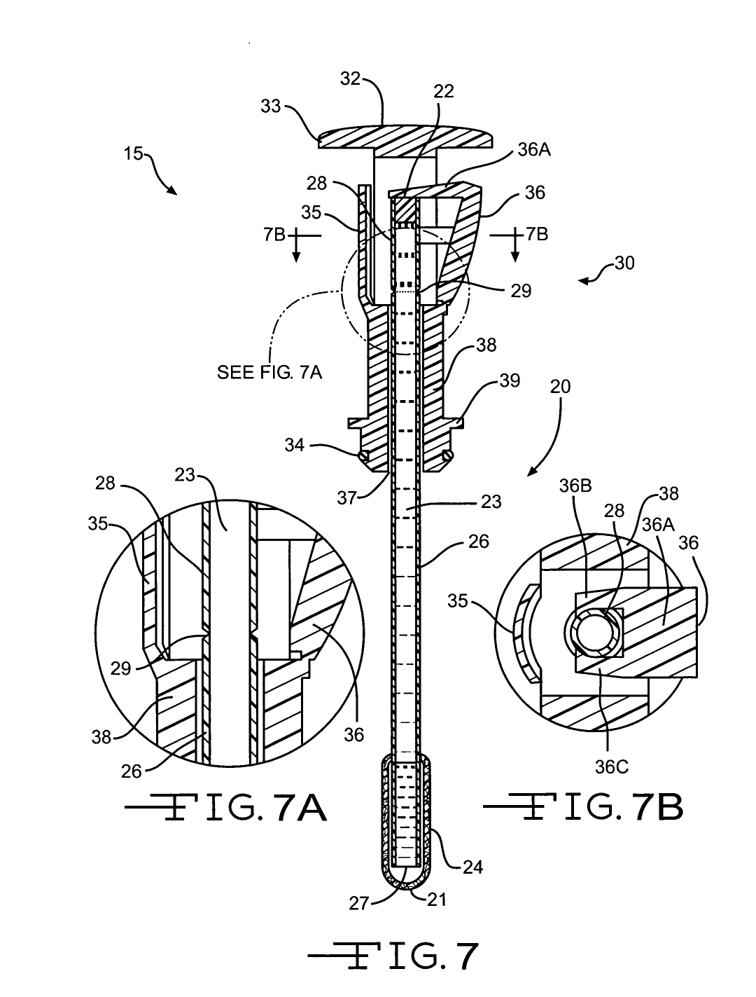

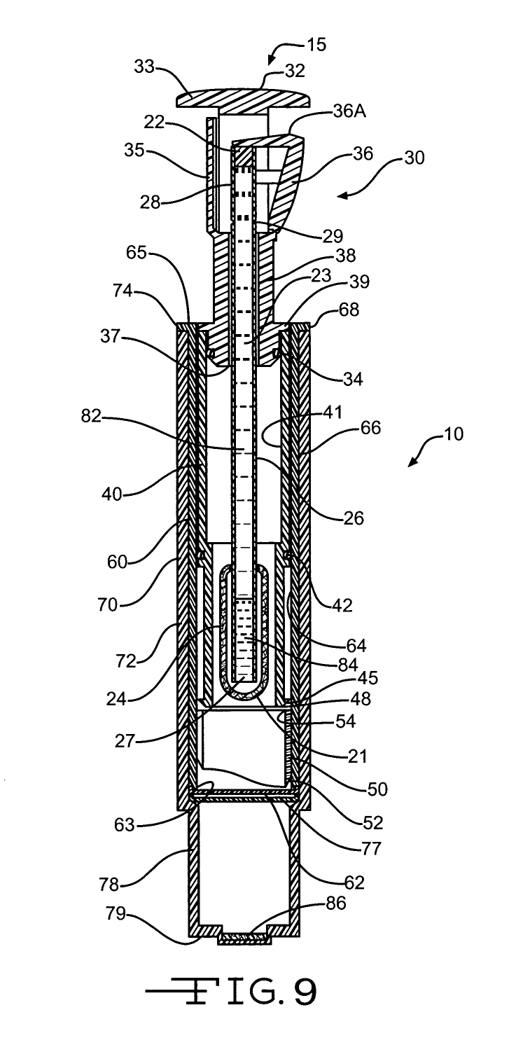

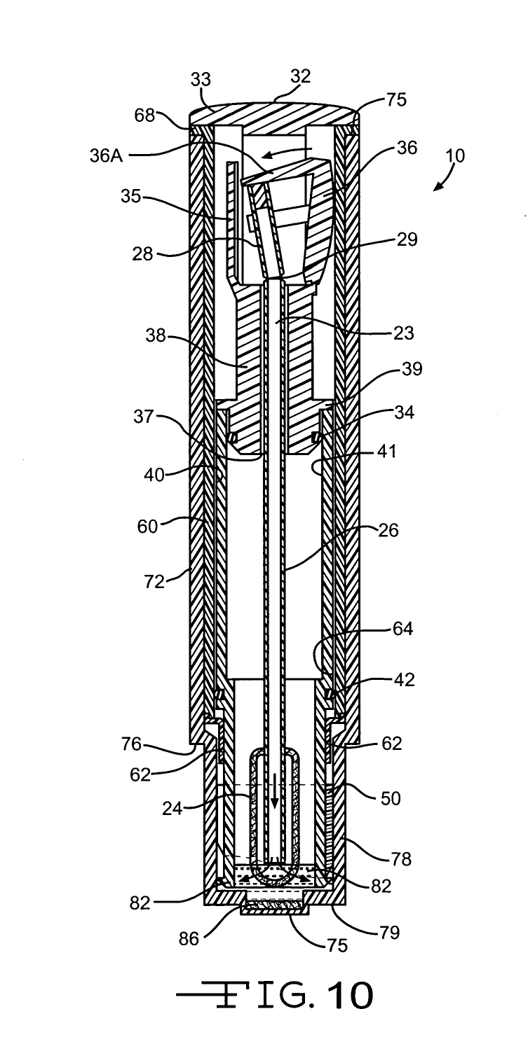

Turning now to the Figures, there is provided in FIG. 1 an illustration of an exploded view of a preferred embodiment of a sampling/analysis member 10 of the present invention. A sampling wand 15 comprising a sampling end 20 at a proximal end 21 of the sampling wand 15 and a handle portion 30 at a distal end 32 of the sampling wand 15 for an operator to hold and manipulate the sampling wand 15. The primary purpose of the grip 33 is to provide a structure that facilitates the operator's manipulation of the sampling wand 15 as the wand is moved between specific positions within the inner chamber 60 of the sampling/analysis member 10. Although the Figures illustrate the grip 33 having a substantially flat cylindrical shape, it will be appreciated that this shape is for illustrative purposes only, and that other, equally useful, geometries are possible and within the grasp of one of ordinary skill in the appropriate art. The sampling end 20 of the sampling wand 15 is comprised of an elongate hollow tubular container 26 having, as best seen in FIG. 7, FIG. 9 and FIG. 10, an open end 27 and an opposed closed end 22 sealed to define an inner reservoir 23. Towards the closed end 22 is a frangible portion 28 of the container 26 which can be broken away from the rest of the container 26 at a score 29 circling the container 26. The closed end 22 of the container 26 is inserted and secured into an opening 37 in a collar 38 on the handle portion 30 to assemble the sampling wand 15.

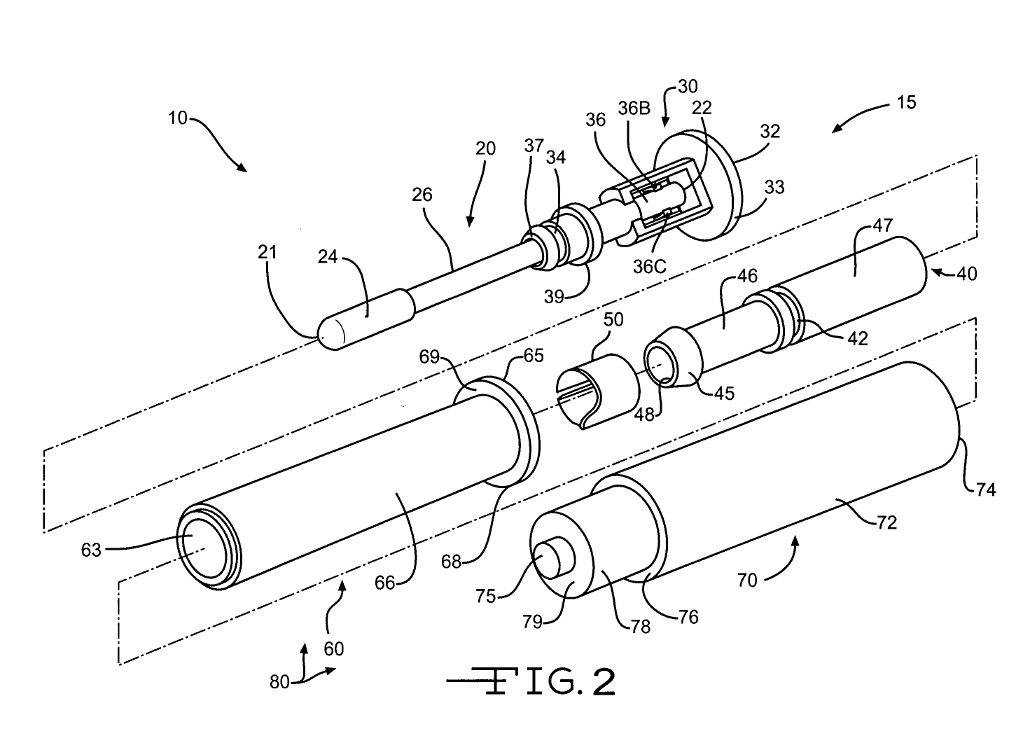

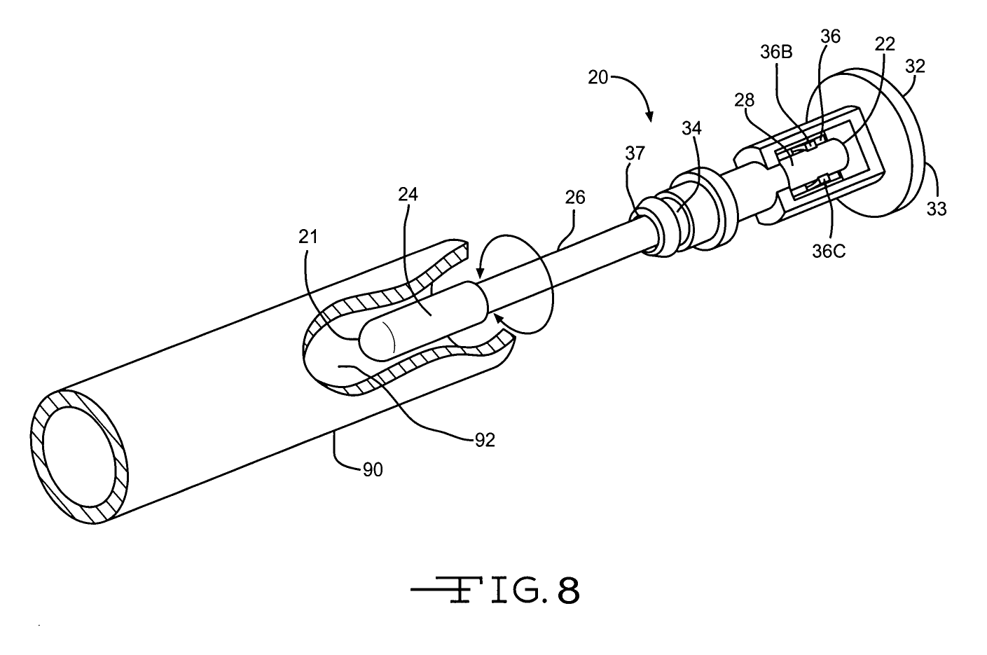

FIG. 2 illustrates the sampling/analysis member 10 with the sampling wand 50 fully assembled. The handle portion 30 securely holds the sampling end 20 by means of the collar 38 fitting over the container 26 towards the closed end 22. When the sampling wand 15 is assembled as shown in FIG. 2, the frangible end 28 of the container 26 is gripped by a rupturing member 36 of the handle portion 30. An end portion 36A of the rupturing member 36 rests directly against the closed end 22 of the container 26. A first finger 36B and second finger 36C of the rupturing member 36 grip the frangible portion 28 of the container 26 on either side as best seen in FIG. 7B. Provided adjacent to the opening 37 on the collar 38 is an inner o-ring 34 for engaging a removable sleeve 40 which secures the sampling wand 15 when inserted into an inner chamber 60 of an analysis structure 80 for analysis. FIG. 8 illustrates how the sampling wand 50 can be inserted into a pipe 90 or other hard to reach places to collect a sample having an analyte of interest from the inside surface of the pipe 90 or similar structures (FIG. 8).

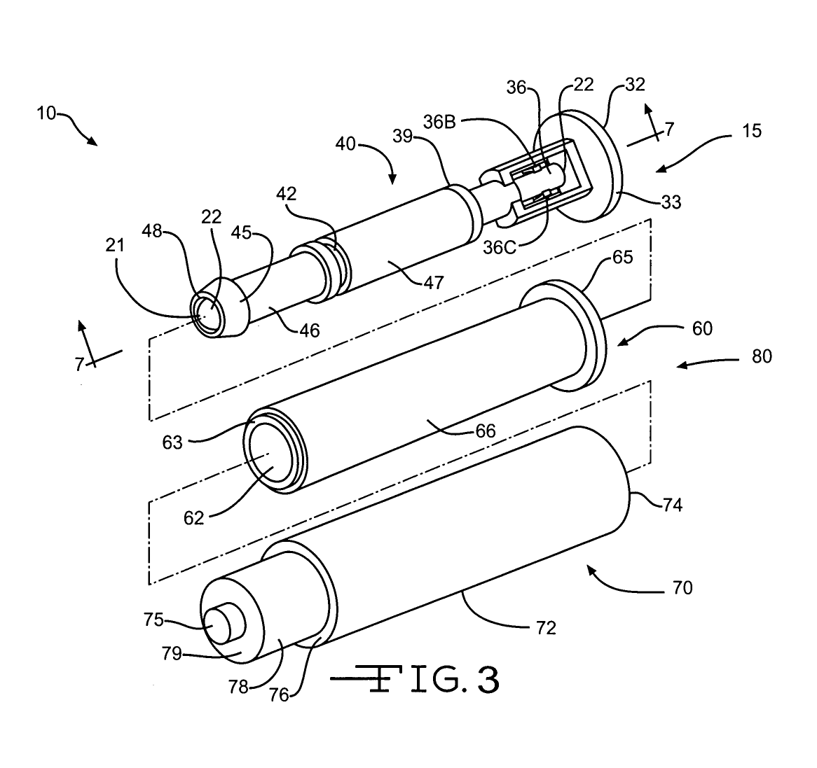

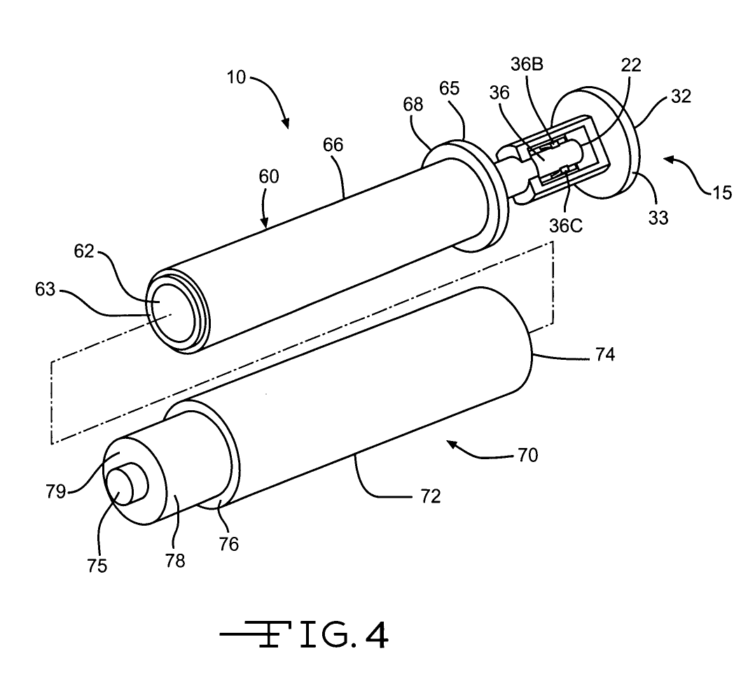

FIG. 3 illustrates the sampling/analysis member 10 with the assembled sampling wand 50 inserted into the sleeve 40 prior to insertion into the analysis structure 80. The sleeve 40 comprises a narrow diameter portion 46 towards a first end 48 and a wide diameter portion 47 towards the second end 44. The inner o-ring 34 around the collar 38 of the handle portion 30 engages the inner surface 41 of sleeve 40 as seen in FIG. 9 and FIG. 10 to secure the sleeve 40 in place over the sampling wand 15. When the sleeve 40 is fully in place over the sampling wand 15 the second end 44 of the sleeve 40 rests against a stop 39 (FIGS. 1, 2 and 9) which protrudes around the collar 38 of the handle portion 30 of the sampling wand 15. Surrounding the sleeve 40 is outer o-ring 42 which engages the inner surface 64 of inner chamber 60 of the analysis structure 80 as best seen in FIG. 9. FIG. 4 illustrates the sampling/analysis member 10 with the sampling wand 15 and sleeve 40 (FIGS. 1 to 3) inserted into the inner chamber 60 of the analysis structure 80. The purpose of the outer o-ring 42 is to provide a sealing fit between the sleeve 40 and the inner surface 64 of the inner chamber 60 of the sampling/analysis member 10, as the sampling wand 15 moves longitudinally through the inner chamber 60.

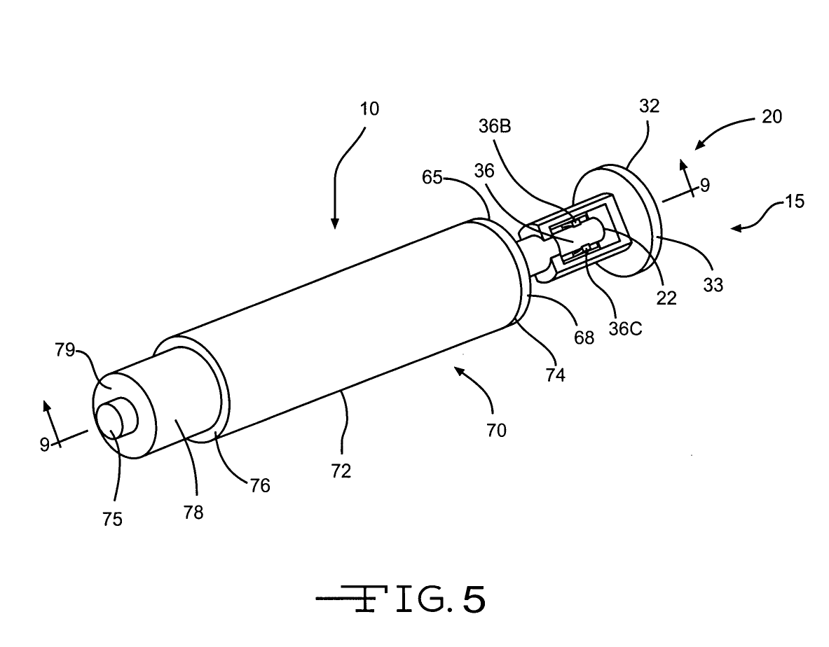

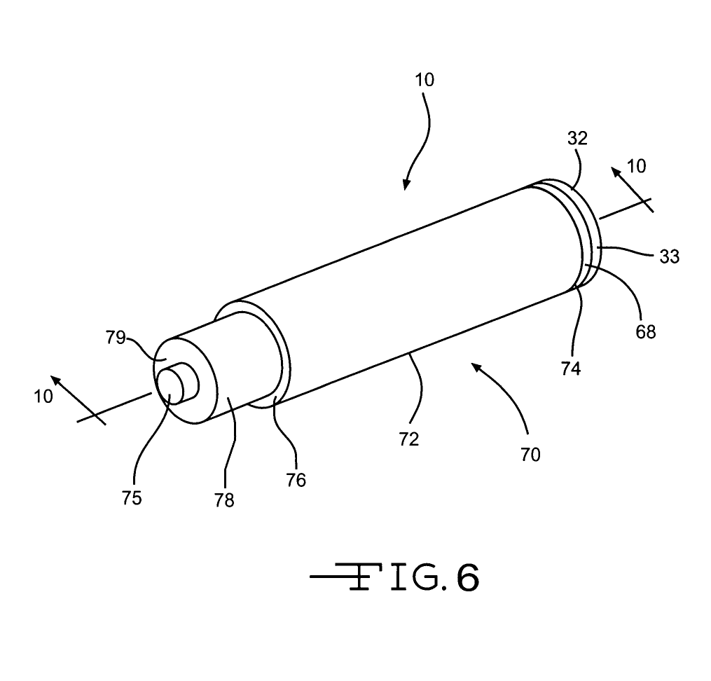

FIG. 5 illustrates an assembled sampling/analysis member 10 with the sampling wand 15 partially inserted to a first position in the analysis structure 80 (FIGS. 1 and 2). When in this first position, a flange 45 at the first end 48 of the sleeve 40 rests against a top edge 54 of a cutting member 50, as seen in FIG. 9. A cutting edge 52 of the cutting member 50 lies in close proximity to a foil seal 62 covering an opening in a first end 64 of the inner chamber 60. The inner chamber 60 of the sampling/analysis member 10 is cylindrical in shape and sized to fit snugly within the outer chamber 70, as best seen in FIG. 9 and FIG. 10. At the other end of inner chamber 60 is second end 65 where a circular rim 68 projects from the outer surface 66. As can also be seen in FIG. 9 and FIG. 10, the analysis structure 80 is substantially cylindrical in shape and is actually comprised, in the embodiment illustrated in the Figures, of two separate but mating components, the inner chamber 60, and the outer chamber 70. As will be recognized by one of skill in the appropriate art, the use of two separate structures in the sampling/analysis member 10 is dictated more by manufacturing concerns than by operational factors and that the present invention contemplates a device that may be constructed of a single chamber. The bottom edge of the rim 68 of the inner chamber 60, in the fully assembled arrangement of the sampling/analysis member 10, rests on the top end 74 of outer chamber 70. Inner chamber 60 is affixed within outer chamber 70 to provide the analysis structure 80. The sampling wand 15 is kept in the first position until the operator is ready to initiate the reaction to detect the sample of interest. At this time, the sampling wand 15 is then fully inserted by forcing the sampling swab 15 into the analysis structure 80 as illustrated in FIG. 6.

Illustrated in FIG. 9 and FIG. 10 are cross-sectional views illustrating structural elements of which the sampling/analysis member 10 is comprised in a first position and final position, respectively. These include a reservoir 23 located within the container 26 of the sampling wand 15. The contents of this reservoir 23 are released into the reaction well 78 of the sampling/analysis member 10 when the frangible portion 28 is broken off at the score 29. The viscosity of the liquid water-insoluble polymer 84 at the open end 27 of the container 26 assists in holding the rinsing solution 82 within the reservoir 23 in the container 26 as long as the frangible portion 28 remains intact as shown in FIG. 9. However upon rupturing the frangible portion 28 at the seal when the sampling wand 15 is moved to the final position as shown in FIG. 10, the liquid water-insoluble polymer 84 no longer can contain the rinsing solution 82 within the reservoir 23 of the container 26. In further embodiments of the invention a porous plug (not shown) can be used having a liquid sealant, such as the liquid water-insoluble polymer 84, in the plug so as to hold the rinsing solution 82 in the container 26 until the rinsing solution 82 is dispensed. In further still embodiments of the invention other types of operable portions (not shown) can be utilized instead of the frangible portion 28 which can be compressed to squeeze the rinsing solution 82 out of the container 26. Other structures which operate to dispense the rinsing solution 82 such as this compressible operable portion are encompassed by the present invention.

The cutting member 50 is substantially cylindrical in shape. Each end of the cutting member 50 is open, and the cutting edge 52 of the cutting member 50 is curved or angled so that the top edge 54 is not parallel to the cutting edge 52. The central axis of the cutting member 50 is co-extensive with the central axis of the inner chamber 60, and the outer chamber 70 of the sampling/analysis member 10. When in the first position as shown in FIG. 9, the cutting member 50 rests against the first seal 62 on the inner surface 64 of the inner chamber 60 at the first end 64, so that movement of the sampling wand 15 further into the analysis structure 80 would perforate the first seal 62 and then second seal 77. Like the first seal 62, the second seal 77 is composed of a frangible material, preferably aluminum foil. Located at the distal end of the outer chamber 70 of the analysis structure 80 is a reaction well 78 that is co-linear along the same central axis as the inner chamber 60 and the analysis structure 70. The diameter of the cylindrically shaped reaction well 78 is slightly smaller than the diameter of the wide portion 72 outer chamber 70. The point of juncture between the walls of the outer chamber 70 and the slightly narrower walls defining the reaction well 78 portion of the outer chamber form a shoulder region 76. In the bottom wall 79 of the reaction well 78 is a reagent disc cavity 75. The reagent disc cavity 75 holds the reagent disc 86.

Second seal 77 is affixed through the use of an appropriate adhesive to the shoulder region 72 of the outer chamber 70. However, in an alternative embodiment of the device, the outer chamber can be constructed without the second seal 77. Manufacturing concerns, rather than operational concerns, will frequently dictate the use of both first 62 and second 77 seals. The final component of the sampling/analysis member 10 illustrated in FIG. 9 and FIG. 10 is the reagent disc 48. The reagent disc 86 sits within a reagent disc cavity 75 in the bottom of the reaction well 78.

FIG. 9 provides a cross-sectional view of the fully assembled sampling/analysis member 10 prior to initiation of the reaction by movement to the final position. It will be possible to gain an appreciation of the relative positioning of the individual components of the member 10 in this assembled state. In this state, the bottom edge 63 of the inner chamber 60 rests on the shoulder region 76 of the outer chamber 70, toward the distal end of that chamber 70. Also apparent are the first 62 and second 77 seals positioned on the bottom edge 63 of the inner chamber 60 and the shoulder region 76 of the outer chamber 70, respectively. It can be seen that the cutting member 50 is positioned within the inner chamber 60 so that the cutting edge 52 which is the cutting edge is positioned directly above the first and second seals, 62 and 77. As provided in the assembled configuration, the sampling/analysis member 10 is provided with a liquid water-insoluble polymer 84 which serves to help maintain the rinsing solution 82 in the reservoir 23 of the container 26. The liquid water-insoluble polymer 84 prevents loss of rinsing solution 82 from within the device until the frangible portion 28 is broken away from the rest of the container 26.

Referring now to FIG. 8, FIG. 9 and FIG. 10, there is illustrated the sequential operation of the sampling/analysis member 10 of the present invention. FIG. 8 illustrates the use of the sampling wand 15, held in a single hand of the operator, to obtain a sample from a surface 92 such as within the pipe 90 suspected of bacterial or protein contamination. The sampling wand 15 is first removed from the inner chamber 60 of the sampling/analysis member 10 and sleeve 40. Once removed, the sampling wand 15 can be placed in close proximity to the surface 92 to be sampled so that the sampling swab 24 contacts the surface. The sampling swab 24 is preferably packaged and sealed in the sampling/analysis member 10 in a pre-wetted state. More preferably, the sampling swab 24 is pre-wetted with a detergent, a hygroscopic agent, or a mixture thereof. In some embodiments, the hygroscopic agent is glycerol, polypropylene glycol, or polyethylene glycol. Preferably the sampling swab 24 is pre-wetted with 10% glycerol. In further still embodiments the sampling swab is pre-wetted with an extracting agent, preferably in an appropriate buffer to maintain the solution at a pH value in the range of 5.7 to 7.5. A preferred extracting agent is a cationic detergent.

Several suitable detergents or combination of detergents are known to those skilled in the art and include nonionic detergents such as Triton X-100, Tween 20, Tween 80, Nonidet P40, n-Undecyl Beta-D glucopyranoside; zwitterionic detergents such as n-hexadecyl-N,N-dimethyl-3-ammonio-1-propanesulfonate; and cationic detergents such as alkyltrimethylammonium bromides, benzalkonium chloride, cetyldimethyl-ethylammonium bromide, dodecyltrimethylammonium bromide, and cetyltrimethylammonium bromide. The concentration of detergent solution varies for each type of detergent and can range from 0.001-10% (wgt/vol). Particularly preferred detergent solution would contain benzalkonium chloride, or similar cationic detergent, at a concentration of 0.01-1% (wgt/vol). It should be noted that, according to the present invention, the exact loadings and capacity of the sampling swab 27 are not absolute. What is important to the practice of the methods of the present invention is that the sampling swab, whatever its specific geometry, or its absolute capacity to absorb and hold a solution of an extracting agent, be loaded with a solution of such agent to a level that is somewhat below the saturation capacity of the swab material.

As can be seen from the Figures, the sampling swab 24 is represented as having a hollow cylindrical geometry partially fitting over the open end 27 of the container 26 like a sock. The sampling swab configured in this way can flex in any direction to conform to surfaces. As should also be apparent to one of skill in the appropriate art, the use of a hollow cylindrical geometry is for illustrative purposes only, and is not intended to limit the range of suitable geometries for the sampling swab 24 in the practice of the present invention. Thus configured, the sampling swab is able flex and reach less accessible portions of the surface to be sampled, such as inside crevices, and around corners or ridges or other surface irregularities, particularly where that surface is not perfectly planar and/or regular.

Once the sampling wand 15 has been used to collect a sample from the surface onto the sampling swab 24, the sampling wand 15 is returned to the sampling/analysis member 10 where the wand 15 is re-inserted into the inner chamber 60 of the sampling/analysis member 10. When first re-inserted, the sampling wand 15 can be returned to its original longitudinal position within the inner chamber 60 of the sampling/analysis member 10. In that position, the member 10 is in substantially the same arrangement as depicted in FIG. 9. In that arrangement, upper seal 62 remains undisturbed, and the contents of the reservoir 23 are held within the reservoir 23.

FIG. 10 illustrates the sampling wand 15 after being moved longitudinally within the inner chamber 60 of the sampling/analysis member 10 to a final operational position. In this position, the sampling wand 15 has been moved downward into the inner chamber 60 of the analysis structure 80 so that the rupturing member 36 is forced against the inner surface 64 of inner chamber 60, thereby transferring force against the frangible portion 28 of the container 26 so as to break off the frangible portion 28 at the score 29. The broken off frangible portion 28 is kept from falling away from the sampling/analysis member 10 and into nearby food by a shield 35 shown in two cross-sectional views in FIG. 7 and FIG. 7B. When the closed end 22 of the container 26 is broken off in this manner a rinsing solution 82 contained therein can freely flow down and out of the reservoir 23 from the open end 27 of the container 26. The rinsing solution 82 thus released travels downward and out of the reservoir 23 and then diffuses through the sampling swab 24. During advancement to the final operational position, the cutting edge 52 of the cutting member 50 is forced to cut through the first and, if present, second seals, 62 and 77, respectively. After penetrating the seals, the sampling wand 15 is advanced into the reaction well 86 before the rupturing member 36 breaks the frangible portion 28 to release the rinsing solution 82 into contact with the sampling swab 24.

In returning the sampling wand 15 to the sampling/analysis member 10, and moving the sampling wand 15 downward to the final operational position, the sampling wand 15 has been fully advanced and the cutting member 50 has punctured the first foil seal 62 and second foil seal 77 and entered the reaction well 78. Once the first end 48 of the sleeve 40 has advanced into the reaction well 78, the cutting member 50 is forced against the bottom wall 79. Further advancement forces the cutting member 50 to expand at a gap 56 running along the length from cutting edge 52 to the top edge 54 of the cutting member 50 and slide over the flange 48 onto the narrow portion 46 of the sleeve 40. The sampling swab 24 soaked with the rinsing solution 82 then can be advanced far enough to squeeze against the reagent disc 86 so as to drive the rinsing solution 82 with the sample of interest from the sampling swab 24 and onto the reagent disc 86 where the reaction proceeds. Preferably, the sampling/analysis member 10 can be inserted into a port of an assay device, preferably a hand-held device, such as a luminometer or spectrophotometer before advancing the sampling swab 15 to start the reaction.

Preferably the rinsing solution 82 in the reservoir 23 contains a neutralizing solution to counteract the effects of any residual cleaning agents, typically chlorine-based, present on the solid surface being sampled with the device of the present invention. In addition, the rinsing solution 82 also preferably contains a buffering agent to maintain the solution at a pH value of approximately 7.5. The rinsing solution can also contain non-ionic detergents such as Tween 80 and Triton X-100, or other species such as cyclodextrins, bovine serum albumin, and other suitable neutralizing species. As the solution diffuses through the sampling swab 24, it effectively rinses the sample obtained from the surface to be analyzed into the solution collected at the bottom of the inner chamber.

As the rinsing solution 82 having sample therein is squeezed into the reaction well 78 of the outer chamber 70, the solution is in contact with the reagent disc 86. As a result of this contact, any reagents contained therein or generally in the reaction well 78 which are wetted are rehydrated. In some embodiments of the sampling/analysis member 10 lyophilized components are supplied sealed within the reaction well 78. In further embodiments, reagents are provided dry within the reagent disc 86. In rehydrated form, the reagents are free to react with the extracellular ATP released from the bacterial species collected from the sampled surface. Once allowed to react, the ATP, if present, will lead to the production of light (luminescence).

Similarly, in further embodiments, reagents can be provided to produce color for protein analysis as provided in U.S. patent application Ser. No. 11/044,147 to Satoh et al. The reaction, in normal practice, occurs within the reaction well 78, inserted in close proximity to the detector of a luminometer or spectrophotometer. Due to the kinetics of the reaction and the solubility of the reagents, at low ATP concentrations optimal luminescent intensity is normally observed within 20-60 seconds of commencement of the chemiluminescent reaction, and possibly within 30-40 seconds. Using techniques known to one of ordinary skill in the appropriate electronics arts, it is possible to design the detector and display circuitry of a luminometer to process the output signal so as to report an optimized reading obtained most likely in that 30-40 second time window of the luminescent reaction. The bottom wall of the reagent disc cavity 75 is transparent so that light from the chemiluminescent reaction taking place within the reaction well 78 is permitted to escape or color is detectable in the reaction well at a detector.

Referring back now to the individual components of the sampling/analysis member 10, it is useful to note certain characteristics and operational specifications of these components. Turning first to the sampling swab 24, successful and optimal practice of the present invention places certain requirements on the material used for the swab 24. As can be seen from the discussion of the prior art provided above, the vast majority of the prior art sampling and/or analysis devices disclosed therein utilize cotton or other fibrous materials, whether natural or man-made, or a combination thereof. Although such materials can be utilized in a variety of applications, the present inventors have determined that practice of the present invention can be optimized through selection of the proper material for use as the sampling swab 24. Toward this end, the preferred material for use as the sampling swab 24 is polymeric in nature, as opposed to the fibrous material that predominates in the prior art. Use of a polymeric material provides a number of advantages in the fabrication of the swab and also its incorporation into the sampling wand 15. First of all, a suitable polymeric material may be cast or formed into an appropriate geometry that facilitates contact of the swab with the surface to be analyzed for the presence of materials derived from microbial organisms, or other analytes of interest. A further advantage of an appropriate polymeric material is that it can be sterilized by steam and/or pressure, or by gamma irradiation. This is a characteristic that is essential given the primary uses of the device of the present invention.

Use of a polymeric material for the sampling swab 24 makes it possible to select and control optimal physical and chemical properties of the swab that enhance the effectiveness of the practice of the present invention. The sampling swab 24 can be pre-wetted, preferably with a 10% glycerol solution. Alternatively, a detergent, a hygroscopic agent, or mixtures thereof can be used to pre-wet the sampling swab 24. Hygroscopic agents such as glycerol, polypropylene glycol, or polyethylene glycol can be used, however other hygroscopic agents known in the art can alternatively be used. It is important to effective sampling of a surface to be analyzed that the sampling swab 24 be pre-wetted with solution at a loading that is somewhat below the saturation capacity of the swab material. With a polymeric material of the sampling swab 24, it is possible to fabricate the swab with specific densities and internal pore sizes so as to be able to achieve specific fluid loading characteristics, and to insure that these characteristics are met uniformly both throughout the swab and also from one swab to the next. A preferred type of polymeric material is composed of the reaction product of polyvinyl alcohol and an aldehyde. In this regard, reference is made to U.S. Pat. No. 4,098,728, the disclosure of which, herein incorporated specifically by reference, teaches methods for the preparation of such polymeric species. However, based on the disclosure contained herein, one of skill in the appropriate art will recognize that other polymeric materials, such as forms of polyvinyl alcohol, will serve as well, provided these materials possess the desired physical and chemical properties.

Although the Figures and the description provided above are primarily directed to the use of the device and methods of the present invention in the sampling of solid surfaces, it should be noted that the device and methods disclosed herein are particularly suited to adaptation for use with other types of samples and alternative methodology. For example, the device of the present invention can readily be used to sample for materials indicative of the presence of microbial species in liquid samples and not just on solid surfaces. To obtain a sample from a liquid source using the sampling wand 15 of the present invention, the swab 24 on the sampling wand can contain an effective amount of an extracting agent such as a detergent. The swab 24 can be loaded with a detergent solution simply by contacting the swab to an appropriate solution. Alternatively, the swab 24 can be further treated after contacting a detergent solution by evaporation of the solvent from the detergent solution, leaving behind the solute detergent species. The specific characteristics of the polymeric material of which the swab 24 is comprised are particularly well suited for this practice due to the large void volume within the polymer and the resulting absorptive capacity of the swab. Furthermore, the large internal surface area within the polymeric material arising from the large void volume provides optimal conditions for the rapid mixing of liquids with the dry reagents, such as a detergent, loaded into the swab 24.

When sampling a liquid, the sampling wand 15 can simply be contacted with the liquid, and the high absorptive capacity of the swab 24 should result in an almost instantaneous wicking of the liquid to be sampled into the swab. Alternatively, the liquid to be sampled can be transferred directly to the swab 24 by a dropper, pipette, or other suitable transfer means. If necessary to acquire a sample of sufficient volume, the size of the sampling swab 24 can be increased. Because it is important for the swab material to retain capacity to absorb additional fluid when sampling a liquid, it is necessary to avoid pre-wetting the swab 24 to absorptive saturation or the swab will be unable to retain a sufficient volume of the sampled liquid. Therefore, care must be taken when wetting the swab 24 when it is the intention of the operator to use the swab 24 in a pre-moistened state. It can be preferable, then, to utilize the swab 24 where the solvent from the detergent solution is evaporated away.

It should be recognized that one of the potential problems associated with sampling liquids is that the analyte of interest, for example bacterial cells, may not be present at sufficiently high concentration levels to provide a meaningful sample. This situation is not unusual when assaying a liquid sample for microbial content. However, it is possible to pre-concentrate the microbial species in the liquid by filtering the liquid through an appropriate filter, such as one with a filter size of approximately 0.2 microns. After the filtering step, the sampling wand 15 can be swiped across the surface of the filtering medium to acquire the concentrated sample. The sampling wand can then be used in a manner consistent with the sampling of solid surfaces, as described above.

The reactant mixtures typically used for assays of the type involved in the practice of the present invention, including luciferase, luciferin, and magnesium ion, are usually sold as a single combined reagent system, not as individual reagents. The luciferase must be within a suitable pH of approximately 7.0 to 8.5 in order to be effective, usually achieved by employment of a buffer system. An appropriate buffer system for the reactant solution would be one comprised of tricine, N-[tris(hydroxymethyl)methyl]glycine ((HOCH₂)₃ C--NHCH₂ COOH), preferably at a concentration of 50 mM, sufficient to maintain the pH of the reactant solution in the range of 7.8 pH units. Alternatively, an appropriate buffer would be N-2-hydroxyethylpiperazine-N′-2-ethanesulfonic acid (HEPES), also capable of maintaining the solution at a pH value of approximately 7.5-7.8. If the proper pH is not maintained, the reaction will not work efficiently, and the results will be erroneous. However, luciferase is unstable while in solution, and will degrade, particularly at higher temperatures. Generally, at room temperature, the luciferase solution will remain effective for a period of hours whereas, at near freezing temperatures, the luciferase solution will last for a period of days. In addition, luciferin in solution is light sensitive. Light causes the dissolved luciferin to degrade, forming chemical species that have an inhibitory effect on the luciferin/luciferase reaction, potentially resulting in false negatives. To prevent degradation, the luciferin and luciferase can be dried and protected from light. Prior art methods for drying include, but are not limited to, freeze-drying and lyophilization. When ready to use, the dried luciferin and luciferase are dissolved in water containing an appropriate buffer to form an aqueous solution having the proper pH.

To address the problem of reagent stability, the present inventors utilize a reagent disc 86, loaded with the chemiluminescent reactants needed to produce the analytical signal (chemiluminescence). A number of commercial enterprises market luciferin-luciferase reagent kits for use in chemiluminescent reaction assays. One that the inventors have found to be particularly well suited for the practice of the present invention is the FIRELIGHT luciferin-luciferase reagent kit provided by Analytical Luminescent Laboratories (ALL) of Sparks, Md. Although ALL provides a number of pre-prepared reagent kits, the present inventors have found that a reagent mixture based on ALL catalog #2005 is particularly preferred, with the only modification from the commercially available catalog formulation being that the luciferase component of the formulation is present at twice the amount in the catalog formulation. This provides for a greater intensity of luminescence, and faster reaction kinetics.

In the preparation of the reagent discs 86, the reactant concentrate is loaded, preferably drop-wise, onto the sheets. The coated sheets are then dried at ambient temperatures under a vacuum, and the reagent discs are cut from the sheets in an appropriate size and shape. Alternatively, discs may be cut first and then loaded with appropriate reagent solution. When loaded in such fashion with the reagent mixture, reagent discs, approximately 6 mm in diameter and approximately 1.5 mm in height, carry approximately 0.5 mg of the dried reactant mixture.

Use of the polymeric material as a medium onto which to load the chemiluminescent reactants offers significant advantages over prior art methods. To begin with, as discussed briefly above, aqueous solutions of luciferin-luciferase at concentrations suitable for typical assay procedures are relatively unstable and cannot be used more than a day after preparation without significant loss of emission intensity, and then only after a recalibration of the emission signal as a function of ATP standard concentration. The recognized prior art solution to the problems associated with instability of aqueous solutions of the reagents is to prepare the reagent mixture in a lyophilized, or freeze dried, form, which composition is then typically coated on the inner surfaces of a reaction vessel. Direct loading onto the durable polymeric material eliminates the need for the lyophilization step in the preparation of the reactants, and also provides for more readily achieved rehydration of the reagents once the reactant disc 86 is in contact with the sample solution. This is due, in part, to the relatively large internal surface area of the preferred polymeric material that provides for almost instantaneous mixing of the reservoir solution with the reagents in the reagent disc 86.

The device and methods of the present invention are also adaptable to additional procedures to enhance, in general, the effectiveness of the assay. For example, it is possible to significantly increase the sensitivity of the assay procedure by utilizing a chemical pre-concentration step. In this manner, a microbial sample is collected according to the procedures described above. Instead of immediately transferring the acquired sample to the analysis structure 80, the sample is transferred to a suitable reaction vessel wherein, according to procedures such as those disclosed in U.S. Pat. No. 5,902,722, the specific disclosure of which is hereby incorporated by reference, all nucleic acids in the sample are converted to inorganic phosphate. By use of such a chemical pre-concentration step, it is theoretically possible to achieve amplification by a factor of 10⁶, or more. Thus, a technique that normally has a threshold sensitivity requiring the presence of from 1,000 to 10,000 microbial cells to generate an analytical signal can detect the presence of a single cell.

In an alternative embodiment of the present invention, the chemiluminescent reagent formulation loaded onto the reactant disc 86 can be prepared with an additional ingredient that provides superior results in the chemiluminescent assay of the present invention. This additional reagent is a common disaccharide. Macromolecular compounds, especially proteins and polypeptide-containing compounds, commonly exist in their naturally occurring hydrated state in the form of complex, three-dimensional folded conformations generally known as tertiary structures. Very frequently, the activity of the compound, whether as an enzyme, antibody, antigen, flavorant, fluorescent, gelling agent, etc., is critically dependent on the tertiary structure and is severely reduced or even eliminated if the structure is disturbed, even though the chemical empirical formula of the compound may not have changed. This is a very serious problem when the protein is required in a dry state for storage. In order to combat this problem various solutions have been proposed. In the prior art, enzymes for dry immunoassay kits have been protected in liposomes.

In addition to the luciferase reactant system disclosed above, it is possible for the device and methods of the present invention to be adapted to assays of additional analytes of interest. In order to achieve this, the reactant mixture would be modified to comprise an alternative enzyme to luciferase, where that enzyme would be capable of oxidizing a specific substrate of interest. Examples of such substrates for which specific enzymes are available would be sugars such as glucose and galactose; lipids such as fatty acids and cholesterol; amino acids and other amines; pyruvate; nicotine adenide dinucleotide (AND) and derivatives; and alcohols. In general, the substrate of interest would be oxidized by the enzyme to generate hydrogen peroxide, H₂O₂, as one of the reaction products. The peroxide, in turn, can react with the specific reactant system in the reagent disc 86, and generate a luminescence signal detectable in the luminometer. Thus, by changing the reactant mixture loaded onto the reagent disc 86, it is possible to adapt the device and methods of the present invention to assays for a wide range of analytes of interest.

A recognized problem associated with chemiluminescent assays of the type disclosed herein, as alluded to in the general discussion above, is that the activity of the chemiluminescent reagents necessary for the assay procedures is sensitive to inhibition by some commonly encountered substances. Of particular importance among these inhibitory substances is the chlorine used in typical cleaning and sanitizing formulations. The presence of residue from chlorine-based cleaners on a surface to be analyzed for the presence of bacterial contamination could lead to false negative results from the assay procedure of the present invention. The likelihood of such an erroneous result is enhanced by the fact that chlorine-based cleaners are frequently used to clean the type of surfaces most likely to be subject to the analyses of the present invention. However, even after the use of such cleaners to ostensibly sanitize, for example, a food preparation surface, it is possible for viable bacterial cells to remain on the surface. In such a case, however, it is likely that chlorine residue from the cleaner would inhibit the luciferin/luciferase-ATP reaction, effectively masking the presence of persistent bacterial contamination, and producing a false negative result. Thus, a food preparation facility, suspecting persistent bacterial contamination of their food preparation surfaces, and expecting the application of present invention, perhaps by municipal authorities, to assess the hygiene of their facility, could utilize a chlorine-based cleaner on the food preparation surface. Although such a cleaner would have some sanitizing effect on the food preparation surface, it is unlikely that its use would be completely effective. However, the inhibitory effect of residual chlorine species from the cleaner would produce a result that would be erroneously read as indicative of a clean surface, free from bacterial contamination. Thus, the purpose of the practice of the present invention would be effectively thwarted.

An alternative embodiment to the present invention provides a procedure to determine whether residual inhibitory species, such as chlorine or other residue from a sanitizing agent, or other treatment, exist on a surface to be analyzed sufficient to cause a false negative result for a bacterial assay according to the present invention. The reservoir 23 provided in the sampling wand 15 of the present invention preferably comprises a neutralizing species in solution. See discussion above. However, it is possible to prepare the rinsing solution 82 for the reservoir 23 to include instead a precisely known quantity of ATP. Thus, use of such a sampling wand in the practice of the present invention, without contacting the sampling swab with the surface to be analyzed, would provide an emission signal in the luminometer of the present invention that would be indicative of the known amount of ATP included in the rinsing solution 82 stored in the reservoir 23. If this sampling swab, with the rinsing solution modified to include a known amount of ATP, is used to first swab a surface to be analyzed for the presence of microbial contamination, then the detected luminescence intensity should be the sum of the intensity from the microbial ATP present in the sample and the known ATP from the rinsing solution. If, however, the assay result obtained is significantly below that expected from the known amount of ATP present in the reservoir solution, then this would indicate inhibition of the chemiluminescent reaction by a species such as residual chlorine on the sampled surface. Thus, the operator would know that use of the conventional sampling/analysis member would be fruitless, as it would likely provide a false negative result. The operator would then have to wait to obtain a meaningful hygiene determination until after the residual inhibitory species is removed from the surface to be analyzed. Thus, the apparatus of the present invention could be provided with both versions of the sampling/analysis member. An operator would first use the embodiment containing the known amount of ATP and, only upon measuring a luminescence signal appropriate for the known amount of ATP in the reservoir, would the operator proceed to use the conventional embodiment of the sampling/analysis member 10 to test the hygienity of the sampled surface.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

I claim:

1. A sampling/analysis member which is used to assay for an analyte of interest in a sample comprising:
(a) a sampling wand having a sampling swab at a proximal end for collecting the sample of the analyte of interest and a distal end for handling of the sampling wand;
(b) a tubular container containing a rinsing solution mounted on the sampling wand with an open end containing a liquid water-insoluble polymer as a stopper for the solution adjacent the swab at the proximal end and a sealed end adjacent the distal end, wherein a portion of the tubular container intermediate the ends is frangible; and
(c) an analysis structure for receiving the sample of the analyte of interest rinsed from the sampling swab by the rinsing solution upon rupture of the portion of the tubular container which is frangible and for retaining the analyte for the detection of the presence of the analyte of interest in the sample.

2. The sampling/analysis member of claim 1 wherein the analysis structure has a reagent disc onto which a reactant system for the analyte in the solution has been loaded.

3. The sampling/analysis member of claim 2 wherein the reagent disc is a polymeric material.

4. The sampling/analysis member of claim 3 wherein the polymeric material is a silicone polymer.

5. The sampling/analysis member of claim 3 or 4 wherein the polymeric material has a cylindrical shape.

6. The sampling/analysis member of claim 1 wherein the tubular container is mounted along a longitudinal axis of the sampling wand.

7. The sampling/analysis member of claim 6 wherein a rupturing member is provided at the distal end of the sampling wand so as to bend the tubular container to rupture the frangible portion.

8. The sampling/analysis member of claim 7 wherein the rupturing member comprises a pivotable arm adjacent to the tubular container at the distal end of the sampling wand.

9. The sampling/analysis member of claim 8 wherein the pivotable arm is bendable so as to pivot.

10. The sampling/analysis member of claim 9 wherein the rupturing member is comprised of a plastic material.

11. A sampling wand comprising:
(a) a sampling swab at a proximal end for collecting a sample of an analyte of interest and a distal end for handling of the sampling wand;
(b) a tubular container containing a solution mounted on the sampling wand with an open end containing a liquid water-insoluble polymer as a stopper for the solution adjacent the swab at the proximal end and a sealed end adjacent the distal end, wherein a portion of the tubular container intermediate the ends is frangible so as to release the solution and water-insoluble polymer into the sampling swab; and
(c) a rupturing member on the sampling wand adjacent to the tubular member for rupturing the portion which is frangible.

12. The sampling wand of claim 11 wherein the tubular container is mounted along a longitudinal axis of the sampling wand.

13. The sampling wand of claim 12 wherein a rupturing member is provided at the distal end of the sampling wand so as to bend the tubular container to rupture the frangible portion.

14. The sampling wand of claim 13 wherein the rupturing member comprises a pivotable arm adjacent to the tubular container at the distal end of the sampling wand.

15. The sampling wand of claim 14 wherein the pivotable arm is bendable so as to pivot.

16. The sampling wand of claim 15 wherein the rupturing member is comprised of a plastic material.

17. A method for assaying for an analyte of interest in a sample which comprises:
(a) providing a sampling wand at a proximal end for collecting a sample of an analyte of interest and a distal end for handling of the sampling wand; a tubular container containing a solution mounted on the sampling wand with an open end containing a liquid water-insoluble polymer as a stopper for the solution adjacent the swab at the proximal end and a sealed end adjacent the distal end, wherein a portion of the tubular container intermediate the ends is frangible so as to release the solution and water-insoluble polymer into the sampling swab; and a rupturing member on the sampling wand adjacent to the tubular member for rupturing the portion which is frangible;
(b) rubbing the swab on the wand on a surface to retain any of the analyte on the swab;
(c) inserting the sampling wand into an analysis structure for receiving the sample of interest;
(d) rupturing the tubular container with the rupturing member so as to release the solution and the liquid water insoluble polymer into and through the swab into the analysis structure; and
(e) detecting any of the analyte in the analysis structure.

18. The method of claim 17 wherein the analysis structure has a reagent disc onto which a reactant system for the analyte in the solution has been loaded and wherein the analyte in the solution reacts with the reactant system.

19. The method of claim 18 wherein the reagent disc is a polymeric material.

20. The method of claim 19 wherein the polymeric material is a silicone polymer.

21. The method of claim 20 wherein the polymeric material has a cylindrical shape.

22. The method of claim 17 wherein the tubular container is mounted along a longitudinal axis of the sampling wand and the rupturing is at the distal end of the tubular container.

23. The method of claim 17 wherein the swab is pre-wetted.

24. The method of claim 23 wherein the swab is pre-wetted with a detergent, a hygroscopic agent, or a mixture thereof.

25. The method of claim 24 wherein the hygroscopic agent is glycerol, polypropylene glycol, or polyethylene glycol.

26. The method of claim 23 wherein the swab is pre-wetted with 10% glycerol.

27. A sampling wand comprising:
(a) a sampling swab at a proximal end of the distal end of the wand for collecting a sample of an analyte of interest and having a distal end for handling of the sampling wand; and
(b) a container containing a solution mounted on the sampling wand with an open end comprising a liquid water-insoluble polymer for the solution adjacent the swab at the proximal end and a sealed end adjacent the distal end, wherein a portion of the tubular container intermediate the ends is operable so as to release the solution and water-insoluble polymer into the sampling swab, thereby enabling the detection of the analyte on the swab in the solution.

28. The wand of claim 27 mounted in an analysis structure for detection of the analyte in the solution.

29. The wand of claim 27 wherein the container is tubular.
